(19) United States
(12) Patent Application Publication
(10) Pub. No.: US 2011/0005123 A1
(43) Pub. Date: Jan. 13, 2011

(54) Pest trap

(76) Inventor: Stephen W. Will, Town of Wadesville, IN (US)

Correspondence Address: Gary K. Price, Esq.;Terrell, Baugh, Salmon & Born, LLP, Suite 2000, 700 South Green River Road, Evansville, IN, 47715, US

(21) Appl. No.: 12/803,588

(22) Filed: Jun. 30, 2010

Related U.S. Application Data
(60) Provisional application No. 61/270,610, filed on Jul. 10, 2009.

(51) Int. Cl. A01M 1/08

(52) U.S. Cl. 43/113; 43/139

(57) ABSTRACT

An insect trap for trapping insects, such as flies, mosquitoes, beetles, etc. The insect trap includes a hollow housing, an power source, an electric motor, a rotatable fan, a light source, a switch, a closure member or hood attached to the housing opposite the base, and a discharge. Upon actuation of the rotating fan, an air stream flows within and adjacent the housing that reduces the pressure and creates a suction. An insect entrained in the air stream will be carried into the open rotating fan by the surge of air of the stream. Once the insect is drawn into the rotating fan, the insect is immediately killed within the housing. While the fan is actuated, air within the housing is continuously exhausted from the discharge. The air being exhausted through the discharge carries the dead insects within the housing through the discharge for disposal.

### CROSS REFERENCES TO RELATED APPLICATIONS

U.S. Provisional Application for Patent No. 61/270,610, filed Jul. 10, 2009, with title “Pest Trap” which is hereby incorporated by reference. Applicant claim priority pursuant to 35 U.S.C. Par. 119(e)(i).

### STATEMENT AS TO RIGHTS TO INVENTIONS MADE UNDER FEDERALLY SPONSORED RESEARCH AND DEVELOPMENT

Not Applicable

### BACKGROUND OF THE INVENTION

1. Field of the Invention

The invention relates generally to the field of pest and insect control devices and more particularly, to an insect or pest trap that uses a light source and vacuum or pressure source to draw insects into the trap.

2. Brief Description of Prior Art.

Pest control devices are well known in the art. More specifically, insect traps heretofore devised and utilized for the purpose of capturing insects are known to consist basically of familiar, expected and obvious structural configurations, notwithstanding the myriad of designs encompassed by the crowded prior art which have been developed for the fulfillment of countless objectives and requirements.

For example, a popular device known in the art uses electricity to kill the flying pest by electrocution. However the continuous noise of the electrocution process is at best troubling and to some, simply unbearable to hear. Also, many of the prior art devices of interest simply discard the trapped/dead insects from the device to the ground surface causing an unsightly mess of dead insects.

While such devices may operate to trap insects, improvements are still desirable to enhance the effectiveness of such insect traps in order to insure that insects that approach the device are in fact captured, insure that the trapped insects are retained and, simplify the disposal of trapped insects. It would also be desirable to provide an improved insect trap which kills the insects trapped so as to further simplify disposal of the insects.

As will be seen from the subsequent description, the preferred embodiments of the present invention overcome shortcomings of the prior art.

### SUMMARY OF THE INVENTION

The present invention is an insect or pest trap for trapping flying insects, such as flies, mosquitoes, beetles, etc. The trap generally includes a base, housing, an electrical power source, an electric motor, a rotatable fan, a light source, a switch, a closure member or hood, and a discharge. Means are mounted in the housing for generating a drawing pressure into the housing and exhausting air from the discharge. In the preferred embodiment, the drawing pressure means comprises the electric power source, the electric motor and rotatable fan. The rotating fan causes an air stream or vacuum-like pressure that draws insects into the housing. The air flows into the housing and is then exhausted from the discharge.

The light source is provided primarily to illuminate areas and to aid in attracting insects to the housing. The light source is also connected to the electric power source for illumination.

Upon actuation of the rotating fan, an air stream flows within and adjacent the housing which reduces the pressure and creates a suction. An insect entrained in the air stream will be carried into the open rotating fan by the surge of air of the stream. The illuminated light source will further attract flying insects toward the housing where the surge of air captures and draws the pest into the rotating fan. Once the insect is drawn into the rotating fan, the insect is immediately killed within the housing and carried through the discharge for disposal.

### BRIEF DESCRIPTION OF THE DRAWINGS

FIG. 1 is a perspective view of a preferred embodiment of the present invention, a pest trap.

FIG. 2 shows the hollow housing of the pest trap shown in FIG. 1.

### DESCRIPTION OF THE PREFERRED EMBODIMENT

In accordance with the present invention, a pest trap for controlling insects such as flies, mosquitoes, beetles, etc, is disclosed. The pest trap is primarily directed to a device for attracting, trapping, killing and disposing of flying insects or pests without the troubling sound of insects being electrocuted and without the unsightly mess of dead insects being discharged on the ground surface. In the broadest context, the pest trap of the present invention consists of components configured and correlated with respect to each other so as to attain the desired objective.

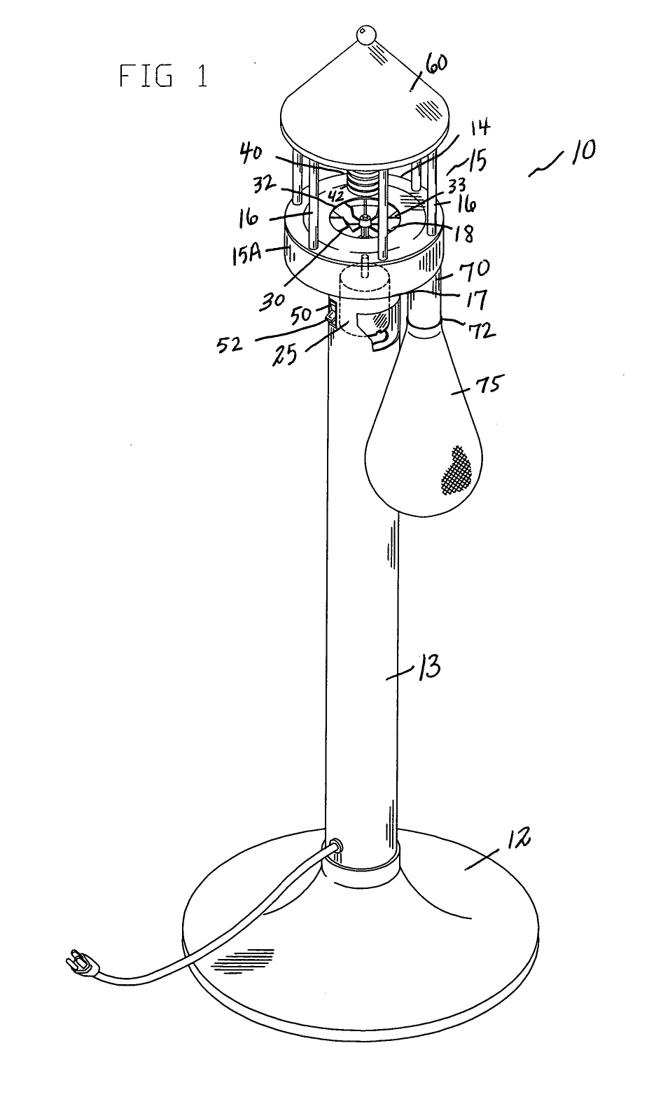

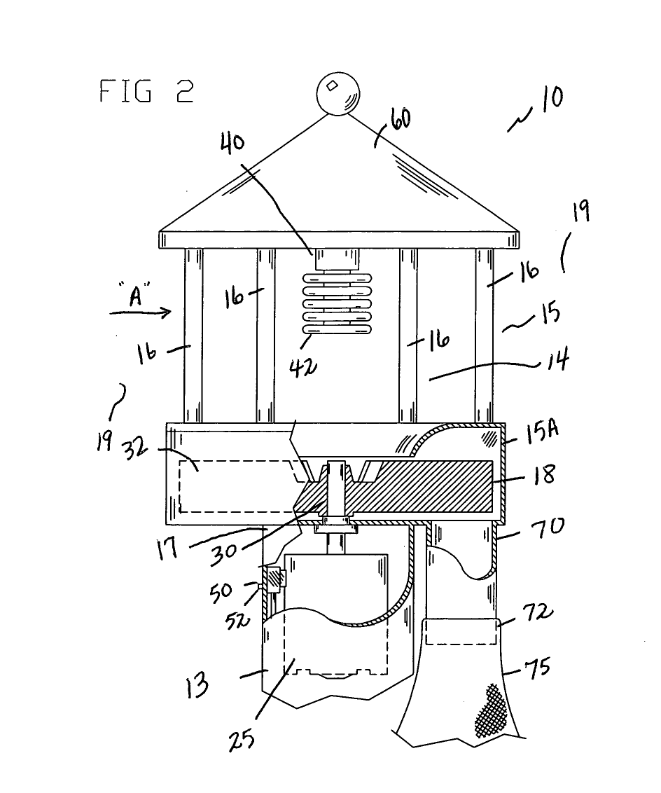

FIGS. 1-2 illustrate the preferred embodiment of a pest trap 10 that is designed to trap pests, such as flies, mosquitoes, beetles, etc., and to dispose of such trapped insects.

The pest trap 10 includes a base 12, a vertical pole 13 attached between the base 12 and a housing 15, an electrical power source (not shown), and electric motor 25 (shown in dashed lines), a rotatable fan 30, a light source 40, a switch 50, a closure member or hood 60, and a discharge 70. The housing 15 is hollow and substantially open to the outside elements, having a plurality of support walls 16 that attach to a base-end 15A of the housing 15 and hood 60. As illustrated, the housing 15 and hood 16 define an interior 14 within the housing 15. Although the housing 15 is illustrated as having a substantially circular cross section, it will be understood that other configurations, such as square, etc., for the housing 15 may also be employed.

The housing 15 base-end 15A further includes an integrally formed compartment 17 to receive and house the electric motor 25, and an integrally formed area 18 for receiving the fan 30. It is critical that the fan 30 not be completely housed in a compartment but open within the housing 15.

Means are mounted in the housing 15 for generating a drawing pressure into the housing 15 and exhausting air from the discharge 70 disposed in the base-end 15A of the housing 15. In the preferred embodiment, the drawing pressure means comprises the power source, the electric motor 25 and rotatable fan 30. The electric motor 25 is appropriately connected to the power source and the rotatable fan 30. The fan 30 includes a plurality of angled, radially extending vanes or blades 32 for rotation upon energization of the motor 25. As illustrated, the vanes or blades 32 include an edge 33 for application.

As will be further described, the rotating fan 30 causes an air stream or vacuum-like pressure that draws insects into the housing 15. The air flows into the interior 14 of the housing 15 (illustrated with Arrows “A” in FIG. 2) and is then exhausted from the discharge 70.

The power source 20 for energizing the electric motor 25 may be driven from a DC power source such as batteries but preferably is driven from an AC current supply to the motor 25 to thereby initiate and terminate rotation of the fan 30.

The light source 40 includes a lamp 42 preferably disposed in the housing 15 and as illustrated, can extend downwardly from the hood 60. The lamp 42 is provided to illuminate areas and to aid in attracting insects to the interior 14 of the housing 15. The light source 40 is also connected to the power source for illumination.

The switch 50 is also electrically coupled to the power source. The switch 50 includes a manually movable operator 52 that is movable from a first or “off” position in which the motor 25 is disconnected from the electric power source, to a second or “on” position in which the motor 25 is supplied electrical power from the power source. As described, energizing the motor 25 results in rotating the fan 30 and illuminating the light source 40.

Upon actuation of the rotating fan 30, an air stream flows within the interior 14 of the housing 15 and an area 19 immediately adjacent the housing 15, which reduces the pressure and creates a suction. An insect entrained in the air stream in the interior 14 or area 19 adjacent to the interior 14 will be carried into the open rotating fan 30 by the surge of air (Arrows “A”) of the stream. The surge of air helps capture the pest before escape flight can occur. An insect or pest becomes entrained in the air stream by simply approaching the housing 15. As is known, an illuminated lamp will attract flying insects. Actuating the lamp 42 will attract insects toward the housing 15 where as previously described, the surge of air captures and draws the pest into the rotating fan 30.

As can be anticipated, once the insect is drawn into the rotating fan 30, the insect is immediately killed within the housing 15. While the fan 30 is actuated, air within the housing 15 is continuously being exhausted from the discharge 70. In this regard, the air being exhausted through the discharge 70 carries the dead insects within the housing 15 through the discharge 70 for disposal.

It is preferable that a discharge bag 75 be releasably attached to a discharge end 72 of the discharge 70. This arrangement permits dead insects being discharged from the housing 15 as described to be collected in the bag 75 and not discharged to the ground surface.

As shown in FIG. 1, the pest trap 10 can be attached to the vertical pole 13 and ground surface or base 12 or, can downwardly extend from an object with a hanging hook (not shown) that is preferably integral to the hood 60.

Although the description above contains many specificities, these should not be construed as limiting the scope of the invention but as merely providing illustrations of some of the presently preferred embodiments of this invention. Thus the scope of the invention should be determined by the appended claims in the formal application and their legal equivalents, rather than by the examples given.

I claim:

1. A pest trap for trapping flying insects, said pest trap comprising:
a hollow housing that includes a compartment and an integrally defined interior,
an electrical power source,
an electric motor disposed within said compartment, said electric motor electrically connected to said power source,
a rotatable fan disposed in said interior, said rotatable fan electrically connected to said power source,
a light source disposed in said interior, said light source electrically connected to said power source,
a discharge,
means for generating a drawing pressure into the housing and exhausting air from said discharge.

2. The pest trap as recited in claim 1, wherein said rotating fan causes an air stream flow that generates said drawing pressure.

3. The pest trap as recited in claim 2, wherein said air stream flows into said housing and is then exhausted from said discharge.

4. The pest trap as recited in claim 3, wherein said air stream flow is generated within said interior and further generated within an area adjacent to said interior of said hollow housing.

5. The pest trap as recited in claim 4, wherein said interior and said area adjacent to said interior are in fluid communication.

6. The pest trap as recited in claim 5, wherein said hollow housing further includes support walls that attach to a hood, wherein said housing and said hood define said interior.

7. The pest trap as recited in claim 6, wherein said electric motor includes a switch electrically connected to said power source, said switch having a manually movable operator that is movable from a first or “off” position in which said electric motor is disconnected from the power source to a second or “on” position in which said electric motor is supplied electrical power from said power source.

8. The pest trap as recited in claim 7, wherein said rotatable fan includes a plurality of blades for rotation.

9. The pest trap as recited in claim 8, wherein said plurality of blades are angled, radially extending blades.

10. The pest trap as recited in claim 1, wherein said light source includes a lamp disposed adjacent the rotating fan within said interior of said housing.

11. The pest trap as recited in claim 1, further including a discharge bag releasably attached to a discharge end of said discharge.

12. The pest trap as recited in claim 1, wherein said hollow housing having a substantially circular cross section.

13. A pest trap comprising:
a hollow housing that includes a compartment and support walls that attach to a hood that defines an interior within said housing,
an power source,
an electric motor disposed within said compartment, said electric motor electrically connected to said power source,
a rotatable fan disposed in said interior, said rotatable fan electrically connected to said power source, wherein said rotatable fan includes a plurality of angled, radially extending blades for rotation,
a light source disposed in said interior, said light source electrically connected to said power source,
a discharge bag releasably attached to a discharge end of a discharge,
wherein said rotating fan creates an air stream that generates a drawing pressure into said interior of said housing and further generates an exhaust air from said interior of said hollow housing through said discharge,
wherein said air stream is generated within said interior and further generated within an area adjacent to said interior.

14. The pest trap as recited in claim 13, wherein said electric motor includes a switch electrically connected to said power source, said switch having a manually movable operator that is movable from a first or “off” position in which said electric motor is disconnected from the power source to a second or “on” position in which the electric motor is supplied electrical power from said power source.

15. The pest trap as recited in claim 14, wherein said light source includes a lamp disposed adjacent the rotating fan within said interior of said housing.

16. The pest trap as recited in claim 15, wherein said lamp extends downwardly from said hood.

17. The pest trap as recited in claim 16, wherein said housing having a substantially circular cross section.

18. The pest trap as recited in claim 13, wherein said power source is a DC power source.

19. The pest trap as recited in claim 13, wherein said power source is an AC power source.

20. The pest trap as recited in claim 13, wherein said housing is attached to a vertical pole, said vertical pole extending from a ground surface.
